(19) United States
(12) Patent Application Publication
(10) Pub. No.: US 2013/0339906 A1
(43) Pub. Date: Dec. 19, 2013

(54) Virtual Reality Promotion Experience

(71) Applicant: Leo Burnett Company, Inc., Chicago, IL (US)

(72) Inventors: Brian Barthelt, Oak Forest, IL (US); Brendon Thomas, Chicago, IL (US); Ariel Hammer, Chicago, IL (US); Michael Miano, Chicago, IL (US)

(21) Appl. No.: 13/921,353

(22) Filed: Jun. 19, 2013

Related U.S. Application Data
(60) Provisional application No. 61/661,576, filed on Jun. 19, 2012.
(60) Provisional application No. 61/662,090, filed on Jun. 20, 2012.

(51) Int. Cl. G06Q 30/06

(52) U.S. Cl. CPC G06Q 30/0643
USPC 715/850

(57) ABSTRACT

A user is provided with an interactive three-dimensional visual environment with which the user can virtually experience a retail setting in association with a promotional campaign. The virtual experience includes a plurality of dynamically-loaded promotional assets which include virtual representations of retail products offered for sale or promotional materials related to the retail products. Promotional assets may be developed in accordance with a promotional theme, and several promotional themes may be developed as part of a product's promotional campaign. To facilitate the visualization of different promotional themes, the user is able to selectively interchange promotional assets in the three-dimensional visual environment to virtually experience the retail setting under each promotional theme and to compare the virtual promotional experiences.

### RELATED APPLICATIONS

This application claims the benefit of U.S. Provisional application Nos. 61/661,576 filed Jun. 19, 2012 and 61/662,090 filed Jun. 20, 2012, both of which are incorporated by reference in their entirety herein.

### TECHNICAL FIELD

This invention relates generally to three-dimensional interactive experiences.

### BACKGROUND

Promotional campaigns or themes are often used in association with one or more products offered to the public for sale. A promotional campaign may use various marketing tools to promote a message or idea to a target audience with the purpose of informing and educating the observer and encouraging or persuading the target audience to take a particular desired course of action, such as purchasing a corresponding product or service.

Promotional campaigns are often designed and intended for deployment in a retail setting where the product and/or service being promoted is displayed and offered for sale. The retail setting may be one where the product along with a competitor's product is offered for sale, or the setting may be one where only products from the same source are offered. As part of the promotional campaign, the product itself along with materials related to the product are typically displayed in the retail setting. The display of these materials is often strategically developed and arranged to attempt to best achieve the desired level of consumer interest and resultant action.

In designing a promotional campaign for a product, an advertising agency may provide several versions or themes of a promotional campaign for the client. As one simple example in these regards, such an agency may well develop a variety of different themed approaches to offering a promotion in conjunction with a given holiday. To present various campaign themes for consideration by the retailer, manufacturer, or distributor, slideshows, posters, story boards, or other visual depictions may be used to illustrate the appearance and placement of the promotional product and related materials in the retail setting. It is also known to present an animated “tour” of a promotionally-theme retail setting as a kind of video short subject. The applicants have determined, however, that none of these prior approaches are necessarily suitable in all application settings for presenting variations of promotional materials and product placement in the context of designing and/or demonstrating a promotional campaign.

### BRIEF DESCRIPTION OF THE DRAWINGS

The above needs are at least partially met through provision of the virtual reality promotional experience described in the following detailed description, particularly when studied in conjunction with the drawings, wherein:

FIG. 1 comprises a block diagram as configured in accordance with various embodiments of the invention;

FIG. 2 comprises a screen shot as configured in accordance with various embodiments of the invention;

FIG. 3 comprises a flow diagram as configured in accordance with various embodiments of the invention;

FIG. 4 comprises a screen shot as configured in accordance with various embodiments of the invention;

FIG. 5 comprises a screen shot as configured in accordance with various embodiments of the invention;

FIG. 6 comprises a screen shot as configured in accordance with various embodiments of the invention;

FIG. 7 comprises a screen shot as configured in accordance with various embodiments of the invention; and

FIG. 8 comprises a screen shot as configured in accordance with various embodiments of the invention;

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a user such as a client for a promotional campaign is provided with an interactive three-dimensional visual environment with which the user can virtually experience a retail setting in association with a promotional campaign. The virtual experience of the retail setting includes a plurality of dynamically-loaded promotional assets located within the three-dimensional visual environment to represent retail products offered for sale or promotional materials related to the retail products. Such promotional materials may include banners, posters, product packaging and informational cards, and other displays.

Promotional assets are developed in accordance with a promotional theme, and several different promotional themes may be developed as part of a product's promotional campaign, resulting in several sets of promotional assets each associated with a promotional theme. For example, promotional themes may vary seasonally so as to correspond to national holidays throughout the year. Promotional themes may also vary geographically to correspond with the target audience in a particular geographic region.

To facilitate the visualization of different promotional themes, the user is able to selectively interchange the set, or a subset thereof, of promotional assets in the three-dimensional visual environment to virtually experience the retail setting under each promotional theme. Because the user is able to selectively interchange the promotional assets, the user is able to easily and readily compare between the virtual experiences associated with each promotional theme.

So configured, the interactive three-dimensional visual environment presents the user with virtual experiences that are more realistic and with more efficiency than prior approaches to presenting a promotional campaign to a viewer.

Prior approaches to developing and presenting various promotional materials and product display arrangements in a retail setting include printing and cutting out physical representations of products and promotional materials and arranging the products and promotional materials on a physical representation of the retail setting. Other approaches include preparing voluminous slideshows to capture visual representations of products and promotional materials in various arrangements and themes in the context of the retail setting, or preparing videos in which the viewer views the retail setting along predetermined pathways without the opportunity for the viewer to interact with the retail setting. These prior approaches can be tedious and inefficient when there are numerous representations of products and promotional materials across multiple promotional themes. Furthermore, these prior approaches have the disadvantages of failing to provide a realistic visual representation of the retail setting and/or failing to provide adequate vision perspective that allows the viewer to experience the promotional campaign to a fuller extent.

The present disclosure provides a virtual promotional experience through the use of an interactive three-dimensional visual environment of a retail setting in which the user is able to selectively interchange promotional assets. In one approach, the user is able to selectively interchange promotional assets to compare the promotional experience provided by each promotional theme.

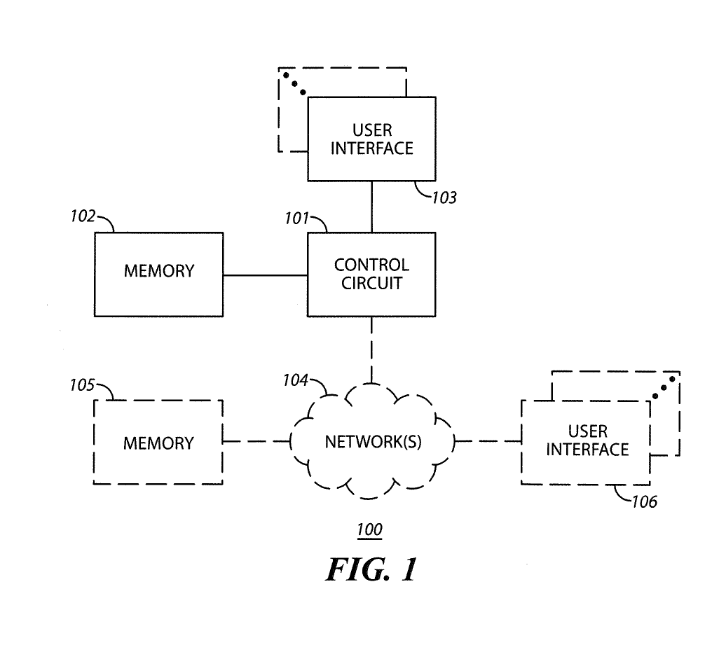

These and other benefits may become clearer upon making a thorough review and study of the following detailed description. The above-described processes are readily enabled using any of a wide variety of available and/or readily configured platforms, including partially or wholly programmable platforms as are known in the art or dedicated purpose platforms as may be desired for some applications. Referring now to FIG. 1, an illustrative approach to such an enabling apparatus will now be provided.

In this example the enabling apparatus 100 includes a control circuit 101 that operably couples to a memory 102 and a user interface 103. Such a control circuit 101 can comprise a fixed-purpose hard-wired platform or can comprise a partially or wholly programmable platform. These architectural options are well known and understood in the art and require no further description here. This control circuit 101 is configured (for example, by using corresponding programming as will be well understood by those skilled in the art) to carry out one or more of the steps, actions, and/or functions described herein.

The memory 102 may be integral to the control circuit 101 or can be physically discrete (in whole or in part) from the control circuit 101 as desired. This memory 102 can also be local with respect to the control circuit 101 (where, for example, both share a common circuit board, chassis, power supply, and/or housing) or can be partially or wholly remote with respect to the control circuit 101 (where, for example, the memory 102 is physically located in another facility, metropolitan area, or even country as compared to the control circuit 101).

This memory 102 can serve, for example, to store the aforementioned dynamically-loaded, selectively viewer-interchangeable promotional assets. This memory can also serve to store information regarding a retail facility or information regarding each of a plurality of promotional assets. This memory 102 can also serve to non-transitorily store the computer instructions that, when executed by the control circuit 101, cause the control circuit 101 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

The user interface 103 can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, printers, and so forth) to facilitate receiving information and/or instructions from a user and/or providing information to a user.

In certain approaches, the control circuit 101 may be connected to one or more communications networks 104 such as a local WiFi network, the Internet, and so forth. The connection to the communications network 104 may be used to provide one or more user interfaces 106 which can remotely display the virtual environment. Connection to the communications network 104 may also be used to provide the control circuit 101 with access to remotely-located memories 105.

Such an apparatus 100 may be comprised of a plurality of physically distinct elements as is suggested by the illustration shown in FIG. 1. It is also possible, however, to view this illustration as comprising a logical view, in which case one or more of these elements can be enabled and realized via a shared platform. It will also be understood that such a shared platform may comprise a wholly or at least partially programmable platform as are known in the art.

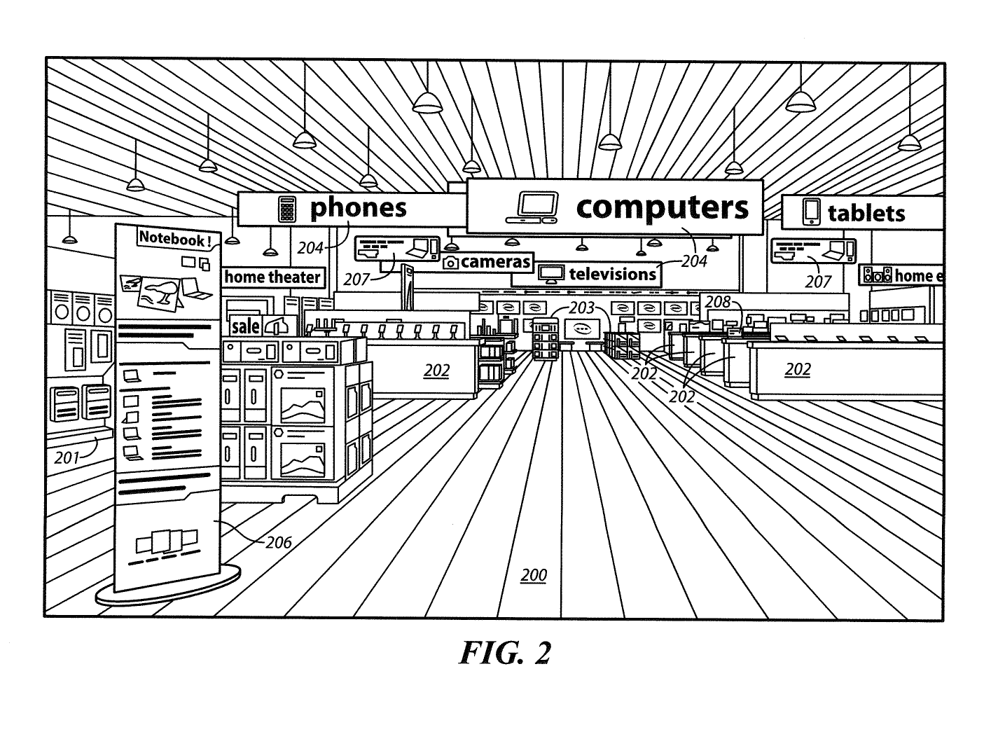

FIG. 2 illustrates an example of an interactive three-dimensional visual environment of a retail setting providing the user with a virtual promotional experience. The three-dimensional visual environment comprises retail setting elements to provide a general feel and layout of the store. The retail setting may be created in accordance with information regarding the retail facility such as store layout maps, blueprints, or other specifications to provide information on store layout, dimensions and positions of shelving units, display racks, and countertops, so-called end caps, floor displays, store signs, lighting specifications, store dimensions, points of entry and departure, points of sale, and so forth, all of which serve to provide a visual representation of the retail setting. The retail setting may be any retail setting such as discount stores, electronics stores, hardware stores, fast food restaurants, movie theaters, clothing stores, or gas stations, to note but a few possibilities in these regards. The retail setting may also be (or at least include) a storefront, including adjacent storefronts for context, as well as the store setting or location.

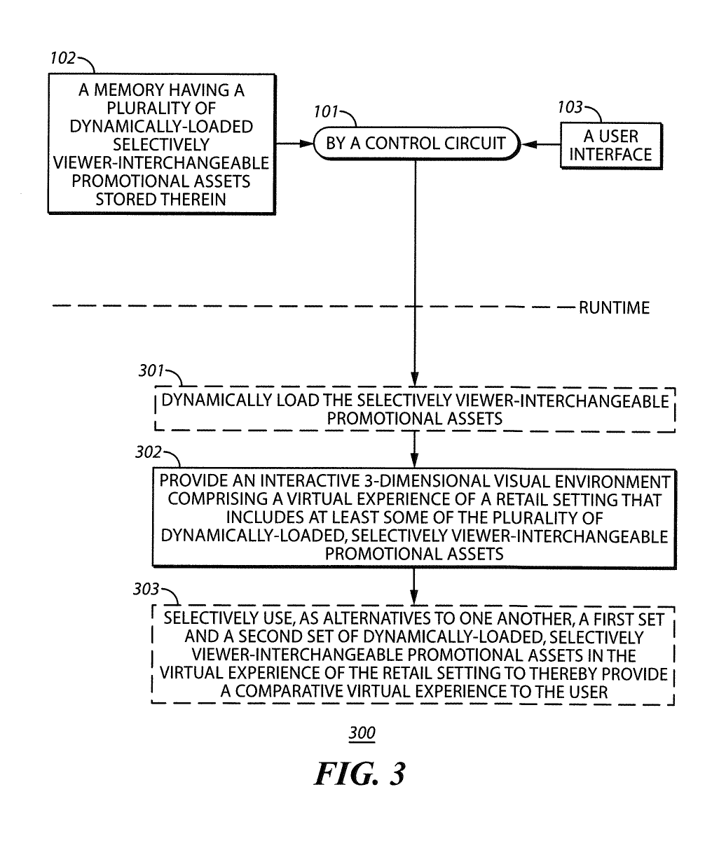

To access the interactive three-dimensional visual environment, the user interface 103 communicates with the control circuit 101 to access and load the plurality of dynamically-loaded, selectively viewer-interchangeable promotional assets stored in the memory 102. At runtime, the control circuit is configured to load the dynamically-loaded, selectively viewer-interchangeable promotional assets. The control circuit is also configured to locate the promotional assets within the interactive three-dimensional visual environment, at least in part as a function of a meta-data based scheme that corresponds to the virtual experience of the retail setting. The user is then able to interact with the three-dimensional visual environment by moving through the store as would a potential consumer to virtually experience the in-store promotional campaign. The user is able to selectively interchange promotional assets to virtually experience each promotional campaign from the viewpoint of a potential consumer. FIG. 3 provides a general overview in these regards.

Pursuant to this illustrative process 300, the control circuit 101 receives user input in a first step 301 at runtime to dynamically load the selectively viewer-interchangeable promotional assets. In a second step 302 the control circuit provides an interactive three-dimensional visual environment comprising a virtual experience of a retail setting that includes at least some of the plurality of the dynamically-loaded, selectively viewer-interchangeable promotional assets. In an optional third step 303, the control circuit selectively uses, as alternatives to one another, a first set and a second set of dynamically-loaded, selectively view-interchangeable promotional assets in the virtual experience of the retail setting to provide a comparative virtual experience to the user.

The control circuit is configured to provide an interactive three dimensional visual environment to a user. The three dimensional visual environment comprises a virtual experience of a retail setting. An example of a retail setting is illustrated in FIG. 2. The retail setting 200 comprises retail setting assets which help set the stage for the interactive three dimensional visual environment. The visual environment shown in FIG. 2 is a view of the retail setting as seen by a customer near the store entrance upon entering the store.

The interactive three-dimensional visual environment is populated by retail setting assets which are virtual representations of retail setting elements such as store shelving units 203, display racks 201, display counters 202, and so forth on which products being offered for sale and promotional materials may be displayed. The three dimensional virtual environment may also include competitors' products for sale as well as competitors' promotional materials associated with its products.

The retail setting assets are made in accordance with store layout maps, blueprints, or other specifications which are available to provide information regarding the retail facility, including dimensions and positioning of shelving units, display racks, and countertops, floor displays, store signs, lighting specifications, and any store fixtures. These retail setting assets which contribute to the store layout also serve to define aisles and pathways along which a consumer may travel in the visual environment. Retail setting assets such as competitor's products offered for sale may be arranged on the visual representations of shelves, display racks, countertops, and so forth in accordance with planograms or other guides to product placement within a retail facility.

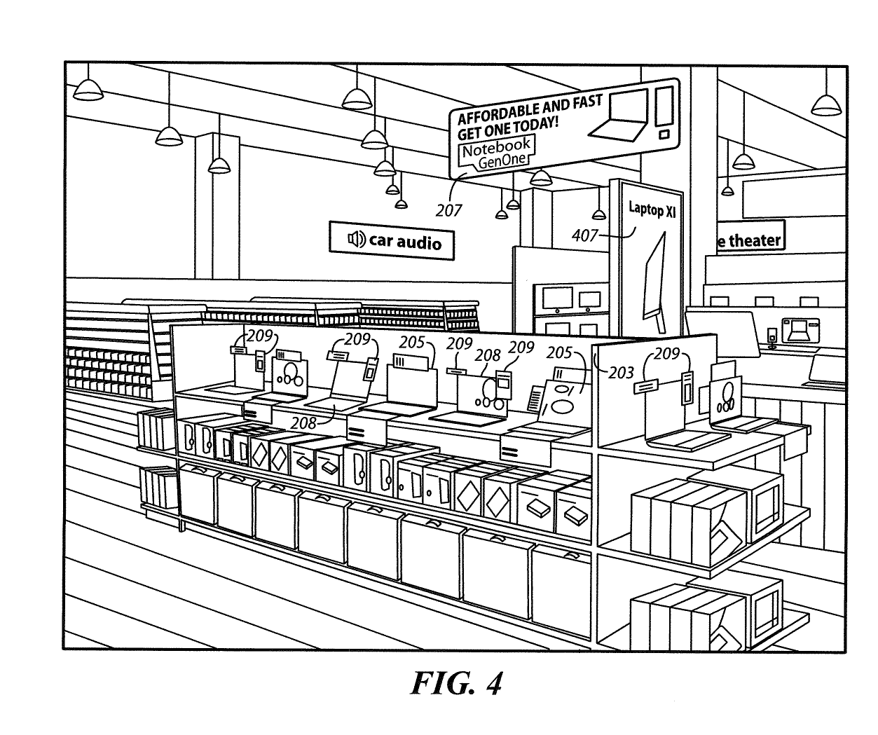

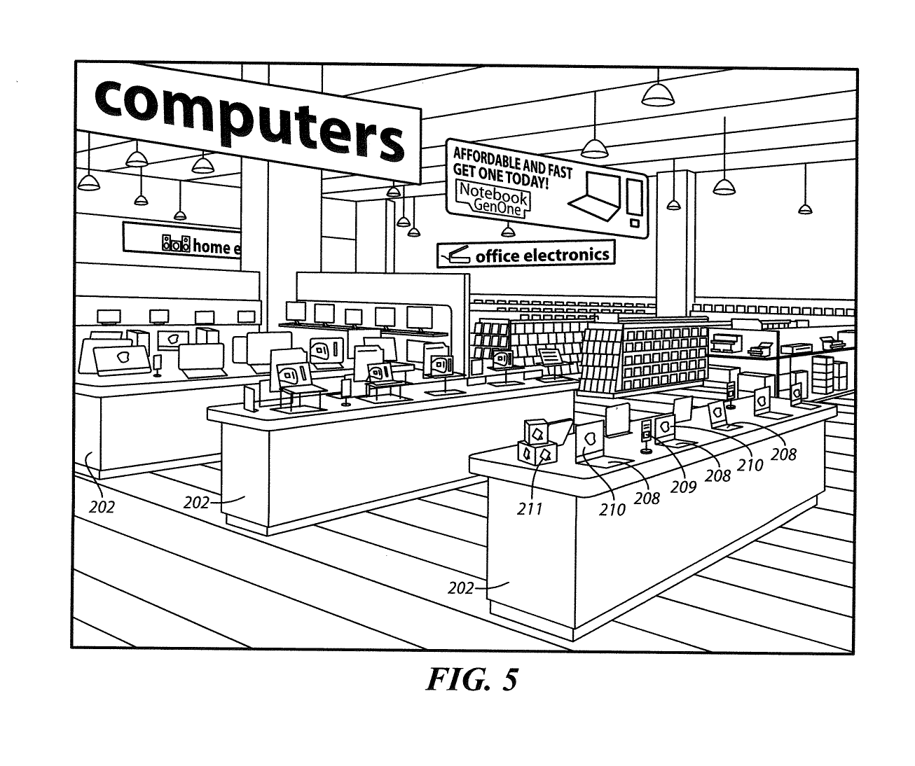

FIGS. 4 and 5 depict aspects of the retail setting 200 in more detail. Using interface controls, the user is able to interact with the three-dimensional visual environment by virtually simulating movement of a consumer along product display aisles. The interactive three-dimensional visual environment allows the user to virtually move towards, for example, a shelving unit 203 (FIG. 4) or rows of countertops 202 (FIG. 5) displaying products offered for sale. As the user moves towards an object, the object appears larger and with more clarity to simulate the vision perspective which was lacking in prior approaches in presenting a promotional experience.

In addition to retail setting assets, the retail setting includes a plurality of dynamically-loaded, selectively viewer-interchangeable promotional assets. Promotional assets can include virtual representations of retail offerings or virtual representations of promotional materials associated with the retail offerings.

In the case of an electronics store, and as an illustrative example, retail offerings may include products such as laptops, tablets, desktops, television sets, phones, and so forth. FIG. 4 illustrates a laptop 208 displayed amongst a competitor's product 205 offered for sale. FIG. 5 illustrates laptops 208 displayed adjacent to each other.

Promotional materials associated with the retail offerings include standees, informational cards, banners, or other informational displays. Visible to the user in FIG. 2 from the vantage point near the store entrance is a standee 206 displaying information related to a retail offering. Also visible to the user are banners 207 displaying information related to another retail offering. The user is able to virtually experience the in-store promotional experience associated with the use of the standee 206 and the two hanging banners 207 in the context of the retail setting from the perspective of a customer that has just entered the store.

In FIGS. 4 and 5, other promotional assets comprising virtual representations of informational cards 209 which may be attached to the laptops 208 (FIG. 4) or displayed adjacent the laptops 208 (FIG. 5) are shown. Promotional assets may also include static or video displays 210 which are shown on the screen of devices offered for sale, as well as other types of informational displays 211. FIGS. 4 and 5 illustrate the virtual experience of the retail setting from the perspective of a customer that is approaching the shelving units 203 in FIG. 4 or approaching the display counters 202 in FIG. 5.

The combination of promotional products and promotional materials in the context of the retail setting which includes the store layout, the competitors' product and the competitors' promotional materials, customizable to any desired consumer perspective view, provides the visual environment for the virtual promotional experience.

The promotional assets are dynamically loaded to allow for the user to selectively interchange promotional assets. At runtime, the control circuit 101 is configured to dynamically load the promotional assets. The promotional assets loaded at runtime may be a default set of promotional assets, or a user-selected set of promotional assets. The control circuit 101 is also configured to locate the dynamically-loaded, selectively viewer-interchangeable promotional assets within the three-dimensional visual environment as function, at least in part, of a meta-data based scheme that corresponds to the virtual experience of the retail setting. In response to user interaction, appropriate promotional assets and elements of the store are selected and dynamically loaded to provide the visual environment with little delay.

The promotional assets are selectively viewer-interchangeable. At the viewer's discretion, a first set of promotional assets may be interchanged with a second set of promotional assets. In one approach, a set of promotional assets may be developed in accordance with a promotional theme wherein the promotional materials may all display a common word, symbol, or image in accordance with the theme. Various promotional themes may be developed as part of a product's promotional campaign. Promotional themes may vary seasonally, so as to correspond to national holidays throughout the year. Promotional themes may also vary geographically to correspond with the target audience in particular geographic regions. A promotional campaign may use various spokespeople such that a set of promotional assets corresponds to each spokesperson within a promotional campaign.

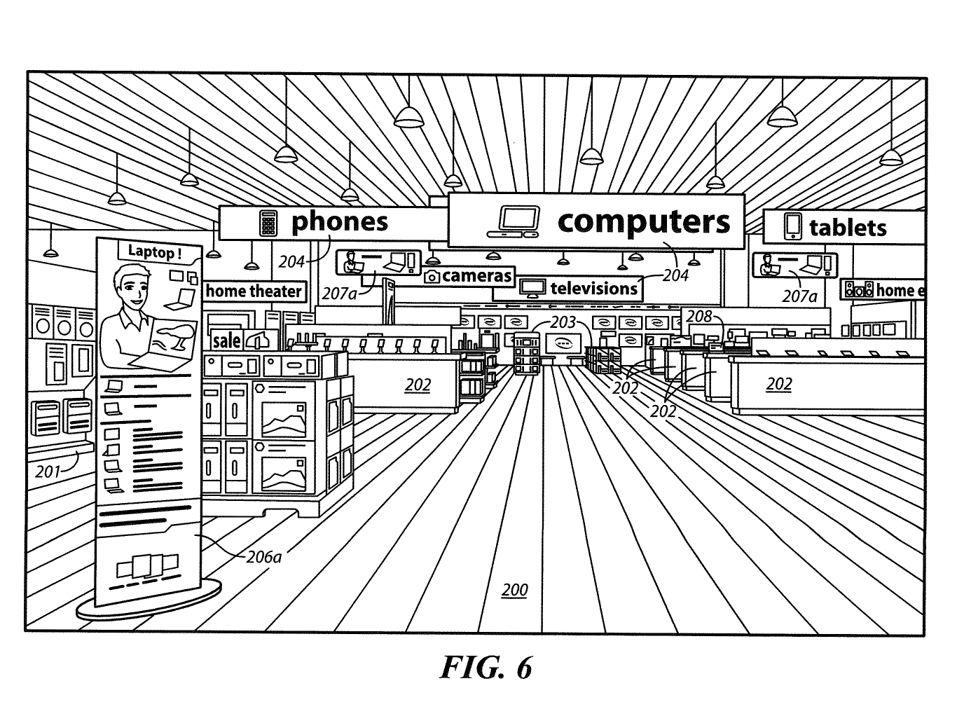

FIG. 6 illustrates the retail setting of FIG. 2 wherein promotional assets 206 and 207 of FIG. 2 are interchanged with a second set of promotional assets 206a, 207a. The standee 206a and banners 207a of FIG. 6 display a second set of promotional assets associated with a second promotional theme. The user is now able to compare the virtual experience provided by the promotional assets in FIG. 2 with the virtual experience provided by the promotional assets in FIG. 6.

As a more specific example, a first promotional theme may be associated with an Independence Day sale. Promotional assets created to correspond with the promotional theme of an Independence Day sale may reflect patriotic images. Promotional assets such as standees 206, banners 207, informational cards 209, static or video displays 210, and other types of informational displays 211 may all depict patriotic images.

A second promotional theme may be associated with a winter holiday sale, wherein the promotional assets 206, 207, 209, 210, and 211 display festive winter holiday images. At the user's selection, the retail setting shown in FIG. 2 may alternate between a first promotional theme wherein the standee and banners display a patriotic image, and a second promotional theme wherein the standee and banners display a festive holiday image. By alternating between sets of assets, the user is able to compare the virtual promotional experiences of the Independence Day sale and the winter holiday sale.

The opportunity for the user to compare virtual experiences provides many advantages to the user. The user is able to navigate through the three-dimensional visual environment and alternate between sets of promotional assets to compare between two (or more) promotional themes at any point in the virtual experience of browsing through the store.

In another approach, the selectively viewer-interchangeable feature of the dynamically loaded promotional asset may assist in determining where to position promotional products and promotional materials to provide the most impact on the customer. Promotional assets may be selectively interchanged so that the second set of promotional assets is displayed elsewhere in the three-dimensional visual environment than are the first set of promotional assets. Referring back to FIG. 2 as an example, in this embodiment, the standee 206 may be selectively interchanged to be positioned elsewhere, such as to the right of the viewer instead of the left so that the user may compare the virtual experience of the standee being on the right when the consumer enters the store, with the experience of the standee being displayed on the left.

In yet another example of selectively interchanging promotional assets to determine where promotional products are to be placed in a retail setting, the user may alternate between virtual experiences to determine, for example, if one standee on the left upon entering the store is more or less effective than two standees set further back on the right towards the display counter 202, and whether either of these standee positions should be used in combination with banners 207, and what the appropriate size of the banners 207 should be to achieve a desired promotional experience. The user is able to interchange the positioning and/or size of the promotional assets to compare the virtual promotional experience provided by each set of positions and/or size of the promotional assets.

In some instances, the user may interchange promotional assets to select between several promotional campaigns. The user is able to interact with the three-dimensional visual environment to an extent desired by the user to virtually experience each promotional theme and select what the user deems would be the more effective promotional campaign.

In other approaches, the user may interchange promotional assets to view previous promotional campaigns. Being able to easily access previous promotional campaigns allows the user to identify previous promotional campaigns that were successful or which did not achieve the desired result. A user may also use this interchangeable feature to ensure that a new promotional campaign will be using themes not previously used.

In yet another approach, the user may interchange promotional assets to access promotional campaigns created for various geographic locations. As promotional themes may vary according to the geographic location of the target audience, a user is able to virtually experience promotional campaigns for different geographic locations. Similarly, retail offerings for a promotional campaign may vary by geographical location. Product assets may be developed to correspond to a first promotional theme selling a first product in a first geographic location, with a second set of product assets developed to correspond to a second promotional theme selling a second product in a second geographic location. A user may use this interchangeable feature to virtually experience promotional campaigns across various geographic locations.

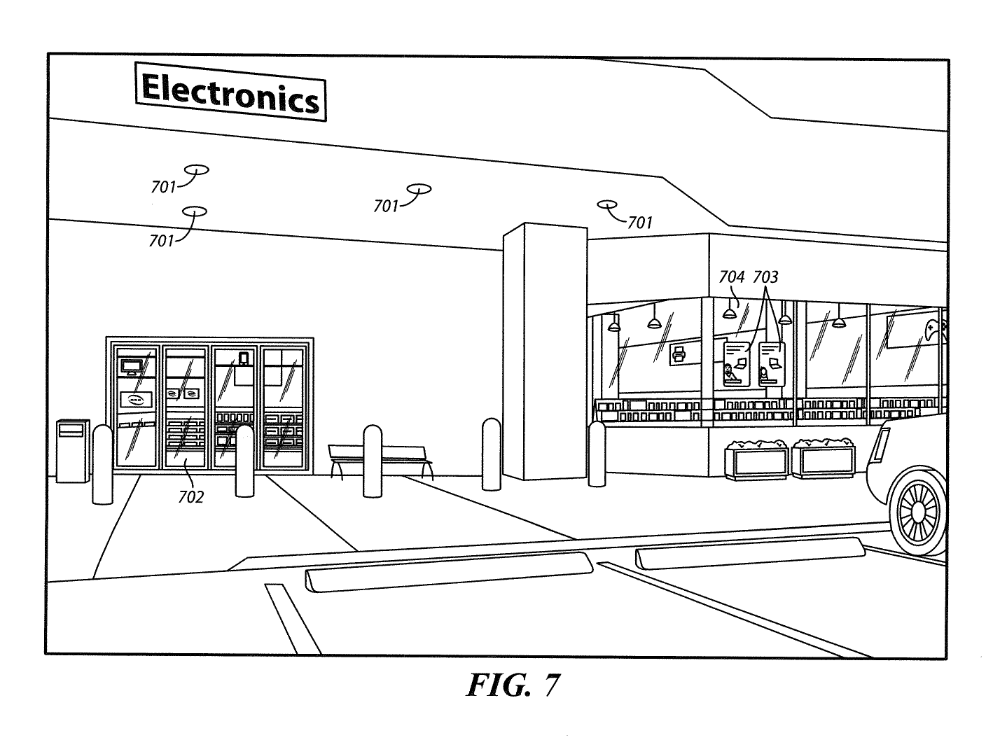

In addition to the promotional assets being selectively viewer interchangeable, various aspects of the three-dimensional visual environment may also be selectively viewer-interchangeable. In one approach, the interactive three-dimensional visual environment provides a virtual experience of a retail setting that includes selectively viewer-interchangeable lighting conditions. As one example in these regards, a user may select between a night time view and a day time view. FIG. 7 illustrates the exterior 700 of the retail setting of FIG. 2. The exterior of the retail setting has lighting 701 near the glass entrance 702, and comprises promotional assets 703 representing posters in the windows 704. In a night time view, the exterior lighting 701 as well as internal store lighting may be turned on. A night time view would provide to the user a virtual experience of the lit storefront at night, with the interior of the store visible through the glass entrance 702 and the 704 windows. A user would be able to view both night and day time virtual promotional experiences to ensure that the desired effect under each lighting condition is achieved. Other lighting factors to take into consideration can include circumstances such as a sunny day or a cloudy day. Promotional assets corresponding to the view on a sunny day may be interchanged with promotional assets corresponding to the view on a cloudy day to provide the user with comparative virtual experiences under these various lighting conditions.

In another approach, the view perspective is also a selectively viewer-interchangeable feature. The interactive three-dimensional visual environment provides a virtual experience of a retail setting that includes selectively viewer-interchangeable perspective views. For example, by one approach the user is able to select a height at which to virtually experience the retail setting. Thus the user is able to view, for example, product assets in the retail setting from the viewpoint of adults with various heights, from the viewpoint of a child, or from the viewpoint of a person in a wheelchair. A user would then be able to view and compare the promotional experiences of consumers of various heights. This feature is particularly useful for viewing promotional campaigns in different geographic regions wherein the target audience may be of different average heights.

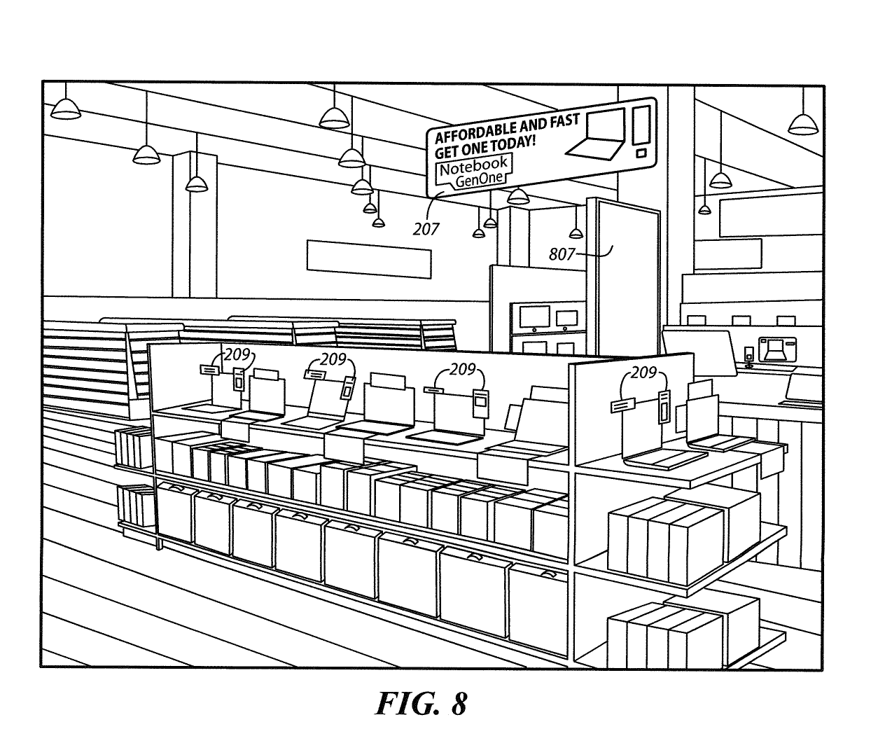

In yet another approach, the viewing mode is selectively viewer-interchangeable. The interactive three-dimensional visual environment is selectively viewer-interchangeable to emphasize the promotional assets and/or de-emphasize the retail setting. The three-dimensional visual environment may be selectively viewed in, for example, a grayscale mode which shows at least some aspects of the retail setting in grayscale mode, yet maintains select promotional assets in color. FIG. 8 illustrates the visual environment of FIG. 4 in grayscale mode. In the grayscale mode depicted in FIG. 8, the retail setting elements and products offered for sale (including promotional products 208) are depicted in grayscale, and also generically represented in shape, while promotional assets 209, 207 remain shown in color. The competitor's promotional material 407 is also interchanged to a generic representation 807. This viewer selective interchangeability is useful to view the location of certain promotional assets, and assess the visibility of a promotional asset within the three-dimensional visual environment once the retail setting is again displayed in color. This grayscale mode allows the viewer to understand instantly which assets within the model are dynamically loaded, and thus comprise the current campaign. This differentiates permanent fixtures from campaign elements.

To interchange the various aforementioned aspects of the interactive three-dimensional visual environment, menu bars or tabs may be displayed on the user interface. The menu bars or tabs may present the various user-interchangeable features for user selection. Once the user indicates a selection, the three-dimensional visual environment is dynamically-loaded with promotional assets to provide the virtual experience of the retail setting selected by the user.

Various other types of retail settings for which an interactive three-dimensional visual environment can be provided include retail settings such as discount stores, hardware stores, fast food restaurants, movie theaters, clothing stores, gas stations, and so forth. The retail setting may offer products from one source (such as a fast food chain, or a brand name clothing store), or the retail setting may offer a variety of competing products (such as a department store). The retail setting may also be a storefront, including adjacent storefronts for context, as well as the store setting or location. An interactive three-dimensional visual environment may also comprise a virtual experience of a retail setting that includes driving to the retail setting and any promotional assets (such as billboards) displayed along the road leading up to the retail setting.

In one approach, the retail setting may be a retail setting such as a fast food restaurant which does not offer any goods from a competitor. Promotional assets comprising virtual representations of promotional materials for retail offerings in a fast food restaurant can include the aforementioned standees, banners, and informational displays, as well as menu boards, menu board icons, promotional toys, posters, food and beverage packaging, and various other promotional opportunities. An interactive three-dimensional visual environment which provides a virtual promotional experience can be used with a fast food retail setting to interchange numerous promotional assets simultaneously.

In some approaches, the menu board may be changed seasonally to reflect a seasonal theme which visually engages with the consumer. Menu icons may also be influenced by a seasonal theme. In some promotional campaigns, limited time, seasonal-only food items may be offered, such as pumpkin spice flavored beverages in the fall or peppermint flavored beverages in the winter holidays.

In one approach, promotional assets may be selectively viewer interchangeable by promotional asset categories. The user may select to only interchange the promotional assets associated with the seasonal themed beverages while keeping other promotional assets unchanged. The user interchangeable assets that are selectively viewer interchangeable by category, such as by the retail offerings (for example beverages), and/or by promotional materials for retail offerings (for example, all window displays) are useful for virtually experiencing the effect of a subset of promotional assets.

In another approach, the interactive three-dimensional visual environment is useful for viewing promotional assets across various retail setting representations. These various retail setting representations may be stores that are part of the same retail chain, yet with different retail layouts, such as, for example, due to location. A store located in a downtown city area may have a small footprint but be several stories tall, whereas another store located in a less dense area may have a larger footprint and be only one storey. In other examples, various retail setting representations may include the same retail chain, but in different geographical locations, such as in different countries. Thus not only are the retail facilities different, but the competitor's product and promotional materials also varies from store to store across different countries. In yet another example, the various retail setting may be different store chains, where the promotional product offered for retail sale may be positioned next to different sets of competitor products and arranged in accordance with each store's layout. The user is provided with a comparative virtual experience of various promotional themes across various retail settings such that the user can select a promotional theme has the desired effect across various retail settings.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

We claim:

1. An apparatus comprising:
a control circuit configured to provide an interactive three-dimensional visual environment to a user, the three-dimensional visual environment comprising a virtual experience of a retail setting that includes a plurality of dynamically-loaded, selectively viewer-interchangeable promotional assets.

2. The apparatus of claim 1 wherein the control circuit is configured to dynamically load the selectively viewer-interchangeable promotional assets at runtime.

3. The apparatus of claim 1 wherein the control circuit is configured to locate the dynamically-loaded, selectively viewer-interchangeable promotional assets within the interactive three-dimensional visual environment as a function, at least in part, of a meta-data based scheme that corresponds to the virtual experience of the retail setting.

4. The apparatus of claim 1 wherein at least some of the plurality of dynamically-loaded, selectively viewer-interchangeable promotional assets comprise virtual representations of retail offerings.

5. The apparatus of claim 1 wherein at least some of the plurality of dynamically-loaded, selectively viewer-interchangeable promotional assets comprise virtual representations of promotional materials for retail offerings.

6. The apparatus of claim 1 wherein the plurality of dynamically-loaded, selectively viewer-interchangeable promotional assets include at least a first set of dynamically-loaded, selectively viewer-interchangeable promotional assets that correspond to a first promotional theme and a second set of dynamically-loaded, selectively viewer-interchangeable promotional assets that correspond to a second promotional theme, the second promotional theme being different from the first promotional theme.

7. The apparatus of claim 6 wherein the user interface is configured to select, as alternatives to one another, using the first set and using the second set of dynamically-loaded, selectively viewer-interchangeable promotional assets in the virtual experience of the retail setting to thereby provide a comparative virtual experience to the user.

8. A method comprising:
by a control circuit that is operably coupled to a memory having a plurality of dynamically-loaded, selectively viewer-interchangeable promotional assets stored therein and to a user interface:
providing an interactive three-dimensional visual environment via the user interface to a user, the three-dimensional visual environment comprising a virtual experience of a retail setting that includes at least some of the plurality of dynamically-loaded, selectively viewer-interchangeable promotional assets.

9. The method of claim 8 wherein the control circuit is configured to provide the interactive three-dimensional visual environment by dynamically loading the selectively viewer-interchangeable promotional assets at runtime.

10. The method of claim 8 wherein the control circuit is configured to provide the interactive three-dimensional visual environment by locating the dynamically-loaded, selectively viewer-interchangeable promotional assets within the interactive three-dimensional visual environment as a function, at least in part, of a meta-data based scheme that corresponds to the virtual experience of the retail setting.

11. The method of claim 8 wherein at least some of the plurality of dynamically-loaded, selectively viewer-interchangeable promotional assets comprise virtual representations of retail offerings.

12. The method of claim 8 wherein at least some of the plurality of dynamically-loaded, selectively viewer-interchangeable promotional assets comprise virtual representations of promotional materials for retail offerings.

13. The method of claim 8 wherein the plurality of dynamically-loaded, selectively viewer-interchangeable promotional assets include at least a first set of dynamically-loaded, selectively viewer-interchangeable promotional assets that correspond to a first promotional theme and a second set of dynamically-loaded, selectively viewer-interchangeable promotional assets that correspond to a second promotional theme, the second promotional theme being different from the first promotional theme.

14. The method of claim 13 further comprising:
selectively using, as alternatives to one another, the first set and using the second set of dynamically-loaded, selectively viewer-interchangeable promotional assets in the virtual experience of the retail setting to thereby provide a comparative virtual experience to the user.

15. An apparatus comprising:
a memory having stored therein:
information regarding a retail facility;
information regarding each of a plurality of promotional assets;
a user interface;
a control circuit operably coupled to the memory and the user interface and configured to:
use the information regarding the retail facility to provide via the user interface a virtual interactive three-dimensional visual experience at the retail facility from the point of view of a mobile consumer;
in response to user selection entered via the user interface, use the information regarding the promotional assets to selectively model the virtual three-dimensional visual experience at the retail facility with respect to a particular promotional campaign.
